(19) United States
(12) Patent Application Publication
(10) Pub. No.: US 2024/0343544 A1
(43) Pub. Date: Oct. 17, 2024

(54) Continuous Pull Corkscrew

(71) Applicant: John Hayes, San Diego, CA (US)

(72) Inventor: John Hayes, San Diego, CA (US)

(21) Appl. No.: 18/607,392

(22) Filed: Mar. 15, 2024

Related U.S. Application Data
(60) Provisional application No. 63/452,549, filed on Mar. 16, 2023.

(51) Int. Cl. B67B 7/04

(52) U.S. Cl. CPC B67B 7/04

(57) ABSTRACT

A continuous pull corkscrew has a long L-shaped handle that provides greater torque than traditional corkscrews, thus allowing for a cork to be removed with less force applied to the corkscrew. Unlike a T-shaped crossbar, the handle has an L-shape an extends outward a significant distance past the body of the corkscrew and the bottle being opened. The resultant reduction in the amount of required force allows for more consumers to use the corkscrew to open wine bottles. The handle is foldable into a closed configuration against the side of the corkscrew body to provide a slim profile for convenient storage.

### RELATED APPLICATIONS

This application claims priority to U.S. Provisional Patent Application Ser. No. 63/452,549 for a “Continuous Pull Corkscrew,” filed Mar. 16, 2023, and currently co-pending, the entirety of which is incorporated herein by reference.

### FIELD OF THE INVENTION

The present invention relates to a continuous pull corkscrew that makes it easier to remove corks from wine bottles. More particularly, the present invention provides a corkscrew with an extended handle. The present invention is particularly, but not exclusively, useful as a continuous pull corkscrew with a reduced strength requirement for use.

### BACKGROUND OF THE INVENTION

Currently there are a wide variety of different corkscrews that are used throughout the world. Different types of corkscrews include waiter corkscrews, electric corkscrews, and continuous pull corkscrews. Continuous pull corkscrews are a popular option for consumers because they do not require a user to physically pull the corkscrew out like with other models. Instead, a user only has to continually turn the handle of the corkscrew and the cork will travel up the worm.

While current models of continuous pull corkscrews may appear to be easy to use for most people, there is one significant drawback to current models.

Current models of continuous pull corkscrews have small a T-shaped crossbar for use as a handle. The crossbar is centered above the worm of the corkscrew and is grasped and turned in a manner similar to garden faucets. The small handles provide little torque, thus requiring users to use a significant amount of strength to operate the device. Consequently, there is a segment of consumers who may be unable to use current models because they cannot generate enough rotational force with their hands or pulling force with their arms.

### SUMMARY OF THE INVENTION

Disclosed is a continuous pull corkscrew that has a longer handle and larger opening that makes it easier to open wine bottles. A preferred embodiment solves the problem of existing models of continuous pull corkscrews with a small handle that requires a user to apply a greater amount of force then necessary to open a wine bottle by the use of a longer handle and wider thumb opening provides for a significant reduction in the amount of force necessary. Unlike a T-shaped crossbar, the handle has an L-shape that extends outward a significant distance past the body of the corkscrew and the bottle being opened. The resultant reduction in the amount of required force allows for more consumers to use the wine opener.

In use, the continuous pull corkscrew is placed around the top of a bottle, and the long handle is rotated clockwise in order to drive the worm into the cork and then to pull the cork upwards out of the bottle. The long handle provides increased torque, allowing for the cork to be removed with less force applied to the corkscrew. After the cork is pulled out of the bottle, the corkscrew itself is lifted away from the bottle, bringing the cork with it. The cork can be removed from the corkscrew by turning the handle in a counterclockwise direction.

In a preferred embodiment, the handle is foldable into a closed configuration against the side of the corkscrew body for easy storage with a slim storage profile.

One major benefit of the long-handled corkscrew is that it is easily positioned and has a long handle so a user of the invention does not have to apply as much force to open a wine bottle. The lower force requirement means that more people are able to use the corkscrew when compared to models currently available for purchase.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a top prospective view of the corkscrew with the handle open;

FIG. 2 is a bottom prospective view of the corkscrew with the handle open;

FIG. 3 is a side view of the corkscrew showing the handle, foil cutter, and bottlecap remover open;

FIG. 4 is a side view of the corkscrew showing the handle, foil cutter, and bottlecap remover closed;

FIG. 5 is a back view of the corkscrew with the handle closed;

FIG. 6 is an exploded view of the corkscrew with the components shown;

FIG. 7 is a section view of the corkscrew with the handle, bottlecap remover, and foil cutter open;

FIG. 8 is a side view of the corkscrew and a wine bottle before the corkscrew is placed on top of the bottle;

FIG. 9 is a side view of the corkscrew placed on top of the wine bottle with the worm outside of the cork;

FIG. 10 is a side view of the corkscrew placed on top of the wine bottle with the worm fully inserted into the cork;

FIG. 11 is a side view of the corkscrew placed on top of the wine bottle with the cork moving up the worm as the handle is turned;

FIG. 12 is a side view of the corkscrew and cork fully removed from the wine bottle;

FIG. 13 is a perspective view of an alternative embodiment of the corkscrew with a foil cutter shown; and

FIG. 13A is a zoom view of the foil cutter at the bottom of the alternative embodiment of the corkscrew.

### DETAILED DESCRIPTION

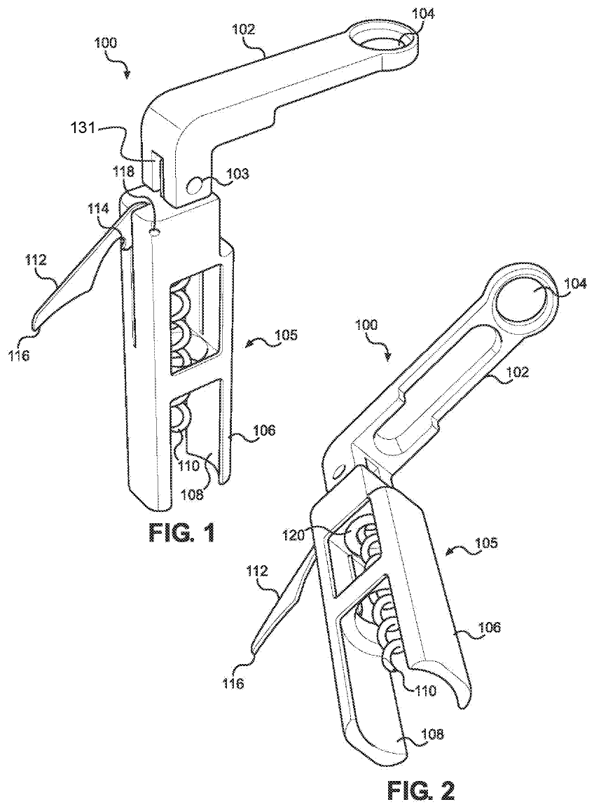

Referring now to FIG. 1, a preferred embodiment of a continuous pull corkscrew 100 is shown. In this figure, handle 102 with thumb opening 104 is shown in the open position. The benefit of handle 102 and thumb opening 104 is that the length of handle 102 requires less force to open the wine bottle. Handle 102 attaches to corkscrew housing 105 at pin 103. Pin 103 is designed to allow handle 102 to open and close with ease. Corkscrew housing 105 is made up of corkscrew exterior 106 and corkscrew interior 108. Tool extension 112 is illustrated in an extended configuration, showing bottlecap opener 114 and foil cutter 116. Tool extension 112 connects to corkscrew housing 105 via pin 118. Pin 118 will allow for tool extension 112, which includes bottlecap opener 114 and foil cutter 116, to open and close with ease.

Referring now to FIG. 2, a bottom perspective view of continuous pull corkscrew 100 is shown. This figure shows worm 110 attached to worm housing 120. Handle 102 is shown in the open position, and tool extension 112 is likewise shown in its extended configuration.

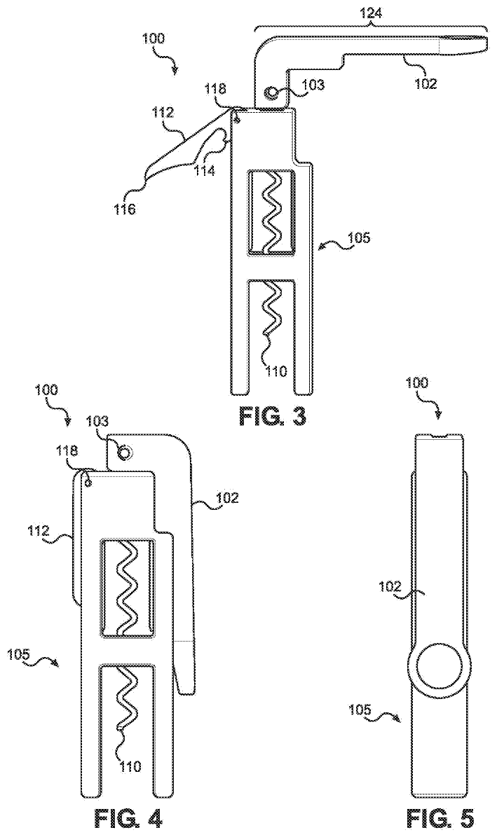

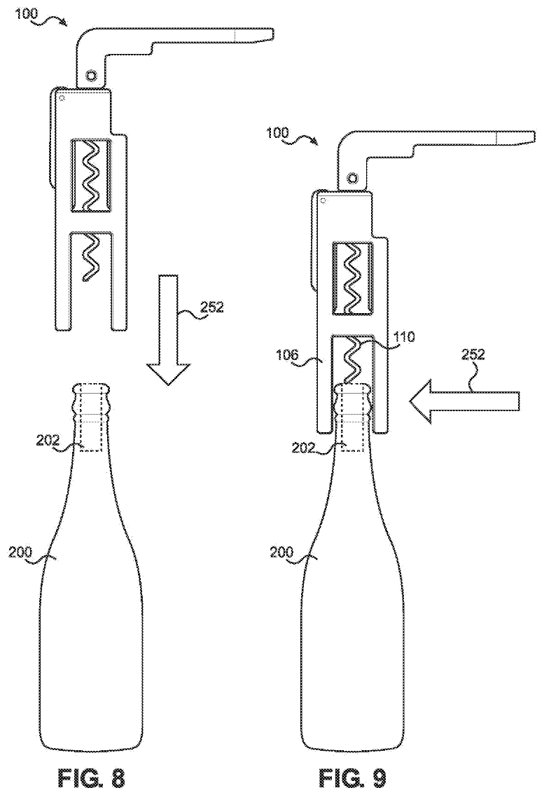

Referring now to FIG. 3 a side view of continuous pull corkscrew 100 is shown. In this figure, continuous pull corkscrew 100 is completely assembled and shows handle 102 in the open position and tool extension 112 in its extended configuration. In the open position, handle 102 extends outward from the top of housing 105. The length 124 of handle 102 is sufficient that it extends outward horizontally significantly beyond the perimeter of housing 105 and the perimeter of the bottle 200 (see FIGS. 8-12) being opened. By having an extended length 124, not only is greater torque provided to make it easier to remove a cork 202 (see FIGS. 8-12), but handle 102 can also be turned without significant twisting motion in the wrist and hand, allowing corkscrew 100 to be operated by people with hand mobility problems who would have difficulty using a traditional continuous pull corkscrew.

Referring now to FIG. 4, a side view of continuous pull corkscrew 100 is shown. Like in FIG. 3, continuous pull corkscrew 100 is completely assembled, but has handle 102 in the closed position. Tool extension 112 is also in its closed configuration, hiding bottlecap opener 114 and foil cutter 116 inside housing 105. To place handle 102 in the closed position, it is rotated about pin 103 until it sits against housing 105. Handle 102 is returned to the open position by rotating it in the opposite direction about pin 103 until it is extended outward at the top of corkscrew 100 as shown in FIG. 3. Likewise, tool extension 112 is alternated between its extended and closed configurations by rotation about pin 118. When handle 102 is in the closed position and tool extension 112 is in its closed configuration, continuous pull corkscrew 100 has a narrow profile that allows the user to easily store the device.

Referring now to FIG. 5, a back view of continuous pull corkscrew 100 is shown with handle 102 in the closed position. This is a view that better illustrates the narrow profile of continuous pull corkscrew 100 when handle 102 is in the closed position and tool extension 112 is in its closed configuration. The ability to alternate the handle 102 between a closed position and an open position provides the benefits of the long handle while retaining the ability to store the corkscrew 100 without taking up more space than a traditional corkscrew.

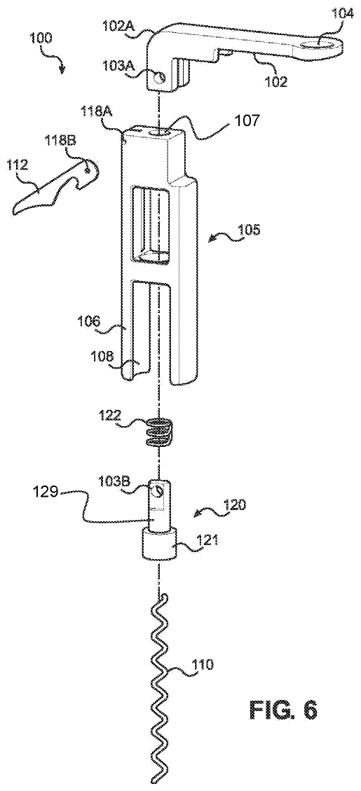

Referring now to FIG. 6, an exploded view of continuous pull corkscrew 100 is shown. Most of the individual components that make up continuous pull corkscrew 100 can be seen in this figure. Corkscrew housing 105 includes corkscrew interior 108 and corkscrew exterior 106. Bottlecap opener 114 and foil cutter 116 are shown to the left of corkscrew housing 105. Worm 110 is positioned within corkscrew housing 105, and worm 110 is what threads into and removes the cork from a wine bottle. Worm 110 is held in place by worm housing 120 when continuous pull corkscrew 100 is fully assembled. Worm housing 120 includes a stop 121 from which worm 110 extends, and a shaft 129 extending from the stop 121 and sized to be received through bore 107 formed in corkscrew housing 105. The diameter of shaft 129 is less than stop 121 so that shaft 129 passes freely through bore 107, but stop 121 cannot pass through bore 107 and is retained within housing 105. Spring 122 encircles shaft 129 at the top of worm housing 120, such that when continuous pull corkscrew 100 is fully assembled, spring 122 is captured in bore 125 of housing 105 between bore 107 and stop 121, and the spring is compressed to provide an extension force to push shaft 129 into bore 107 thereby pulling handle 102 firmly against housing 105. Handle 102 and thumb opening 104 is shown at the top of the exploded view.

As shown in the exploded view, handle 102 has a transverse aperture 103A below and proximate elbow 102A, and shaft 129 of worm housing 120 has a corresponding transverse aperture 103B near its top. In the assembled corkscrew 100, apertures 103A and 103B are aligned and receive pin 103 to retain handle 102 against corkscrew housing 105. Stop 121 of worm housing 120 has a broader diameter than shaft 129, retaining base 121 inside bore 123 in corkscrew housing 105 and allowing shaft 129 of worm housing 120 to extend through the bore 107 formed in the top of corkscrew housing 105 to hold handle 102 in place. Pin 103 hingably connects handle 102 to worm housing 120 such that it can be adjusted between the open and closed positions, but rotates worm housing 120, thus causing worm 110 to rotate, when handle 102 is rotated by a user.

Shaft 129, in a preferred embodiment, is formed with a non-circular cross-section, and handle 102 is formed to closely receive the non-circular portion of the shaft 129. This close reception of the shaft 129 into the handle 102 facilitates the rotation of worm housing 120 and corresponding worm 110 with handle 102 without the entire force of the rotation bearing on pin 103. Specifically, because the shaft 129 is closely received in a corresponding non-circular receiver 131 (See FIG. 1), pin 103 simply retains the handle 102 on the shaft 129 and does not significantly aid in imparting the rotational force transfer from handle 102 to shaft 129.

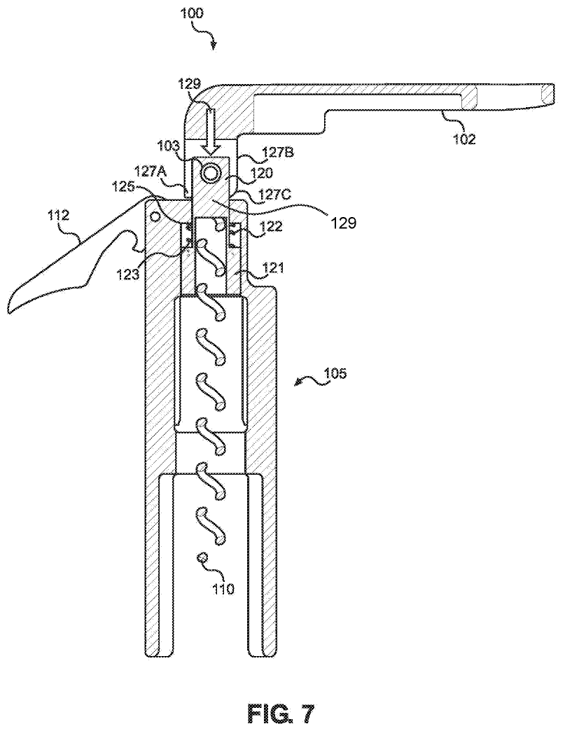

FIG. 7 shows a section view of continuous pull corkscrew 100 fully assembled. Handle 102 is in the open position, and tool extension 112 is in its extended configuration. This view also shows worm 110 permanently attached to worm housing 120.

Also, to be appreciated from the section view of FIG. 7, shaft 129 of worm housing 120 passes through spring 122 which is captured within bore 123 of housing 105 and between stop 121 of worm housing 120 and the end 125 of bore 123. Specifically, the spring 122 is partially compressed, with the proximal end of spring 122 is in contact with corkscrew housing 105 while the distal end of spring 122 is in contact with stop 121 of worm housing 120 causing worm housing 120 to seek to move in direction 129. When handle 102 is in the closed position for storage, spring 122 is partially compressed and urges worm housing 120 away from end 125 of bore 123 which maintains flat surface 127B of handle 102 against the body 105 and the handle 102 in the closed position. Similarly, when the handle 102 is in the open position ready for use, spring 122 is again partially compressed and urges worm housing 120 away from end 125 of bore 123 which maintains flat surface 127A against the body 105 and the handle 102 in the open position.

The force of spring 122 urges base 121 in direction 129 away from end 125 of bore 123 and maintains the position of handle 102 in the open position or closed position. Due to the rectangular pivot edge 127C of handle 102, when the handle 102 transitions from the open to closed position, due to pivot edge 127C pin 103 is urged opposite direction 129 and away from body 105 and spring 122 is further compressed. In a preferred embodiment, spring 122 provides a force sufficient that handle 102 seeks either the open or closed position to decrease the compression on spring 122.

FIGS. 8-12 are a series of side views that show how a user of continuous pull corkscrew 100 will use the device to remove cork 202 from wine bottle 200. FIG. 8 is the first side view of continuous pull corkscrew 100 and wine bottle 200. This figure shows continuous pull corkscrew 100 above wine bottle 200 before being placed on top of wine bottle 200. The user will need to move continuous pull corkscrew in direction 250 to place the device on top of wine bottle 200.

In FIG. 9, continuous pull corkscrew 100 is placed on top of wine bottle 100 with the distal end of worm 110 resting on top of cork 202. The user applies pressure in direction 252 to the portion of corkscrew exterior 106 that covers wine bottle 200. A user will do this by squeezing the overlapping portion of corkscrew exterior 106. This step stabilizes both continuous pull corkscrew 100 and wine bottle 200 while the user is opening wine bottle 200.

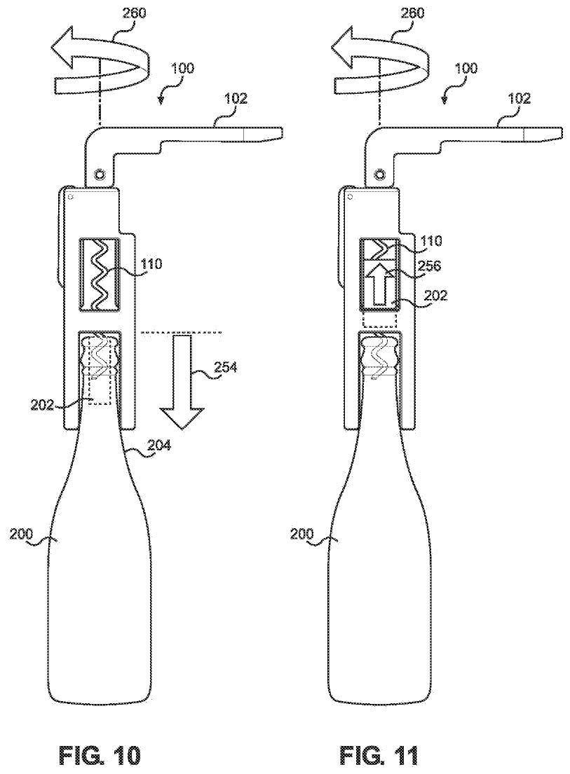

FIG. 10 shows handle 102 being turned in a clockwise direction so that worm 110 can insert into cork 202. The rotational force applied by the user by turning handle 102 in direction 260, a clockwise direction in preferred embodiments, will translate to worm 110 so that it can pierce the material of cork 202. As worm 110 becomes embedded into cork 202, corkscrew 100 continues its motion in direction 254.

As illustrated in FIG. 11, after a couple of turns by the user, the force applied by worm 110 will dislodge cork 202 from the interior of wine stem 204 and force cork 202 to travel up worm 110 as shown in FIG. 11. Corkscrew 100 no longer travels downward in direction 254 (see FIG. 10), but instead cork 202 is drawn upward in direction 256 and out of bottle 200 by the rotation of worm 110.

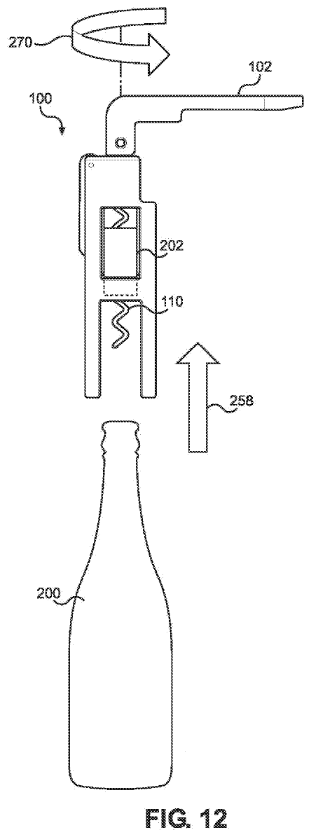

FIG. 12 shows cork 202 fully removed from wine bottle 200. Once cork 202 has been dislodged, corkscrew 100 is removed from bottle 200, as indicated by direction 258. Once cork 202 is fully removed, a user may rotate continuous pull corkscrew 100 in direction 270, which is a counterclockwise direction in preferred embodiments, to remove continuous pull corkscrew 100 and cork 202 from wine bottle 200. In embodiments in which direction 260 is counterclockwise, direction 270 is generally clockwise.

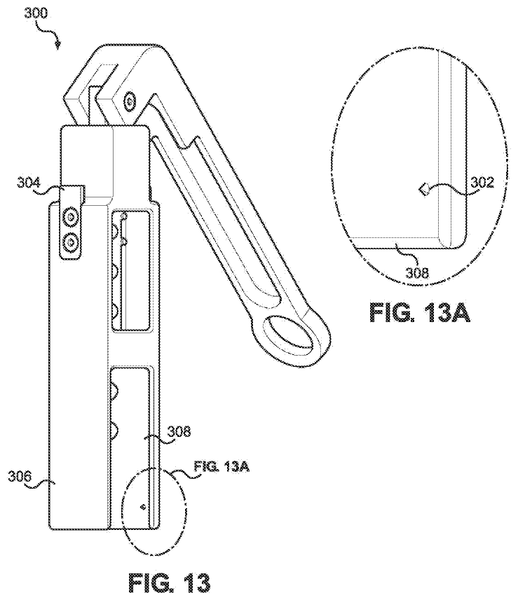

Referring now to FIGS. 13 and 13A, an alternative embodiment of continuous pull corkscrew 300 is shown. The distinction in this embodiment is that continuous pull corkscrew 300 has foil cutter 302 installed at the distal end of corkscrew interior 308. A benefit of this embodiment is that it allows a user to cut and remove the foil without the use of a separate tool. A user can use this feature by placing continuous pull corkscrew 300 on top of wine bottle 200. Once continuous pull corkscrew 300 is placed on top of wine bottle 200, a user must apply enough force to the distal end of corkscrew exterior 306 so that foil cutter 302 pierces the foil on wine stem 204 of wine bottle 200. A user simply has to rotate continuous pull corkscrew 300 a full three hundred sixty (360) degrees either clockwise or counterclockwise so that the foil is now in two separate pieces; one piece to be removed with cork 202 and the second piece to remain on wine bottle 200. With the foil removed, a user will follow the same operating instructions as explained for the prior embodiment. In other embodiments that include foil cutter 302, it may be possible for the user to extract cork 202 and the cut portion of foil at the same time. Finally, this embodiment of continuous pull corkscrew 300 will still be able to remove caps off bottles with bottlecap opener 304. Embodiments that incorporate any or all of the illustrated and above-described features of corkscrew 300 into the features discussed above in connection with corkscrew 100 (see FIGS. 1-12) are also fully contemplated.

While there have been shown what are presently considered to be preferred embodiments of the present invention, it will be apparent to those skilled in the art that various changes and modifications can be made herein without departing from the scope and spirit of the invention.

I claim:

1. A continuous pull corkscrew comprising:
a worm housing having a stop and a shaft extending from said stop;
a corkscrew housing formed with a bore sized to receive said shaft and having an exterior, and an interior, with said interior sized to receive at least a portion of the top of a corked beverage bottle;
a worm having a proximal end and a distal end, with said proximal end connected to said stop of said worm housing and said distal end extending into said interior of said corkscrew housing; and
said shaft passing through said bore of said corkscrew housing and attached to a handle.

2. The continuous pull corkscrew of claim 1, wherein the wherein the handle is L-shaped.

3. The continuous pull corkscrew of claim 2, wherein the handle further comprises an opening some distance opposite of the connection between the handle and said shaft of said worm housing.

4. The continuous pull corkscrew of claim 3, wherein the interior surface of the corkscrew housing includes a foil cutter.

5. The continuous pull corkscrew of claim 4, wherein the corkscrew housing includes a tool extension.

6. The continuous pull corkscrew of claim 1 further comprising a spring captured over said shaft between said stop and said corkscrew housing;

7. The continuous pull corkscrew of claim 1 wherein said shaft further comprises a transverse aperture, and said handle further comprises a corresponding transverse aperture, and a pin extending through said transverse aperture and said corresponding transverse aperture to pivotally connect said handle to said shaft about said pin.

8. The continuous pull corkscrew of claim 7, wherein said handle is configurable from a first configuration wherein said handle extends perpendicularly to said shaft, and a second configuration wherein said handle is substantially parallel to said shaft.

9. The continuous pull corkscrew of claim 8, wherein said handle is “L” shaped.

10. The continuous pull corkscrew of claim 1 wherein said handle comprises a proximal end attached to said shaft of said worm housing, and a distal end formed with an opening.

11. The continuous pull corkscrew of claim 1, wherein said shaft has a non-circular cross-section, and said handle has a receiver formed with a corresponding non-circular cross-section to receive said shaft.

12. The continuous pull corkscrew of claim 11, wherein said non-circular cross-section of said shaft has two parallel sides, and wherein said corresponding non-circular cross-section of said receiver of said handle comprises two parallel sides corresponding to said parallel sides of said shaft.
